(19) United States
(12) Patent Application Publication
(10) Pub. No.: US 2022/0324226 A1
(43) Pub. Date: Oct. 13, 2022

(54) DROP-BASED REMEDIAL ACTIONS FOR A PRINTHEAD

(71) Applicant: HEWLETT-PACKARD DEVELOPMENT COMPANY, L.P., Spring, TX (US)

(72) Inventors: Andrei Alexandru Dafinoiu, Sant Cugat del Valles (ES); Andreu Vinets Alonso, Sant Cugat del Valles (ES); Marina Cantero Lazaro, Sant Cugat del Valles (ES)

(73) Assignee: HEWLETT-PACKARD DEVELOPMENT COMPANY, L.P., Spring, TX (US)

(21) Appl. No.: 17/228,915

(22) Filed: Apr. 13, 2021

(51) Int. Cl. B41J 2/125; B41J 2/045

(52) U.S. Cl. CPC B41J 2/125; B41J 2/04535; B41J 2/04536; B41J 2/0456

(57) ABSTRACT

In one example in accordance with the present disclosure, a method, system, and non-transitory machine-readable storage medium are described. A drop characteristic measurement of a drop of print fluid ejected from a printhead is detected. The drop characteristic measurement includes at least one of a drop velocity and a drop weight. The drop characteristic measurement is compared against a threshold value. When the drop characteristic measurement is beyond the threshold value, a remedial action is triggered.

### BACKGROUND

A printhead is a component of a print system that ejects drops of print fluid, such as ink, onto a substrate to form text and/or images. A small volume of print fluid may be held in an ejection chamber. An actuator such as a thermal actuator may activate to expel print fluid through a nozzle onto a substrate. A controller selectively activates the actuators at predetermined times in order to form text and/or images on a substrate.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a system for carrying out drop-based remedial actions for a printhead, according to an example of the principles described herein.

FIG. 2 is a diagram depicting the system for carrying out drop-based remedial actions for a printhead, according to an example of the principles described herein.

FIG. 3 is a flow chart of a method for carrying out drop-based remedial actions for a printhead, according to another example of the principles described herein.

FIG. 4 depicts various drop velocity output graphs, according to an example of the principles described herein.

FIG. 5 depicts various drop velocity output graphs, according to an example of the principles described herein.

FIG. 6 is a flow chart of a method for carrying out drop-based remedial actions for a printhead, according to another example of the principles described herein.

FIG. 7 is a flow chart of a method for carrying out drop-based remedial actions for a printhead, according to another example of the principles described herein.

FIG. 8 depicts a non-transitory machine-readable storage medium for carrying out drop-based remedial actions for a printhead, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Printing involves the deposition of a print agent, such as ink, toner, or the like on a substrate in a pattern to form text and/or images. A printhead is a component of a print system that includes a number of ejectors. Through these ejectors, print fluid, such as ink, optimizers, and fusing agent among others, is ejected. Specific examples of devices that rely on printheads include inkjet printers, multi-function printers (MFPs), and additive manufacturing apparatuses (also known as 3D printers). For example, in an additive manufacturing apparatus, the fluid ejection system dispenses fusing agents. The fusing agent is deposited on a build material, which fusing agent facilitates the hardening of build material to form a three-dimensional product.

Other printheads dispense ink on a two-dimensional print medium such as paper. For example, during inkjet printing, ink is directed to a printhead die. Depending on the content to be printed, the device in which the printhead is disposed determines the time and position at which the ink drops are to be released/ejected onto the print medium. In this way, the printhead releases multiple ink drops over a predefined area to produce a representation of the image content to be printed. Besides paper, other forms of print media may also be used.

Accordingly, as has been described, the systems and methods described herein may be implemented in two-dimensional printing, i.e., depositing fluid on a substrate, and in three-dimensional printing, i.e., depositing a fusing agent or other functional agent on a material base to form a three-dimensional printed product.

Additionally, the systems and methods described herein may be implemented in print systems that incorporate different types of printheads. For example, the ejector may be a firing resistor. The firing resistor heats up in response to an applied voltage. As the firing resistor heats up, a portion of the fluid in an ejection chamber vaporizes to generate a bubble. This bubble pushes fluid out the opening and onto the substrate. As the vaporized fluid bubble pops, fluid is drawn into the ejection chamber from a passage that connects the ejection chamber to a fluid feed slot, and the process repeats. In this example, the printhead may be a thermal inkjet (TIJ) printhead.

In another example, the ejector may be a piezoelectric device. As a voltage is applied, the piezoelectric ejector changes shape which generates a pressure pulse in the ejection chamber that pushes the fluid out the opening and onto the substrate. In this example, the printhead may be a piezoelectric inkjet (PIJ) printhead.

While such printheads undoubtedly have advanced the field of precise fluid delivery, some conditions may impact their effectiveness. For example, in some systems, the ejectors on a printhead are subject to many cycles of heating, drive bubble formation, drive bubble collapse, and fluid replenishment from a fluid reservoir. Over time, and depending on other operating conditions, some ejectors may become blocked or otherwise defective. For example, particulate matter, such as dried ink or powder build material, can block the nozzle. This particulate matter can adversely affect the formation and release of subsequent printing fluid. Other examples of scenarios that may impact the operation of a printing device include a fusing of the printing fluid on the ejector element, surface puddling, and general damage to components within the nozzle.

As yet another example, deterioration of the electrical or mechanical components as well as the wearing down over time of other electrical components such as the ejectors may impact fluid ejection. Ejector performance may affect a velocity of the drop of print fluid exiting the printhead. A change to the drop velocity may affect the position on the substrate where the print fluid is deposited. For example, the substrate and/or the printhead may move at a particular speed. The print system includes a controller that, knowing the movement of the substrate and/or the printhead, precisely ejects print fluid such that the print fluid lands at particular locations on the substrate to form text and/or images. If the drop velocity changes, a particular drop of fluid may land in an unanticipated location, which may reduce the overall print quality. That is, a change in drop velocity may affect the travel time of the drop to the substrate. Given that printing occurs in a scanning motion, there is an impact in dot placement.

As another example, changes in performance of the ejector may affect a drop weight, or the amount of fluid that is ejected with each ejection event. For example, as a printhead is used more and more, there may be a drop in the weight of each ejected drop of print fluid. Changes in drop weight change the amount of colorant deposited. A different amount of deposited colorant affects the resulting color at a particular location of the text and/or images. Such variation in color is undesirable as it represents a variation between an intended color for the text and/or images and an actual color of the text and/or images. That is, drop weight changes over a threshold amount may lead to perceptible differences between an intended coloration and an actual printed coloration. As the process of depositing fluid on a surface is a precise operation, these interruptions can have a deleterious effect on print quality.

As such, over time, the natural deterioration of the printhead may lead to color consistency and accuracy degradation and overall image quality degradation. While print systems and printheads may be calibrated to account for such inconsistencies, such calibration efforts may be triggered by a user initiating the calibration operation. As these remedial actions are user-based, they may be performed too late, i.e., after numerous jobs have been printed from an uncalibrated and misaligned print system, and may otherwise be susceptible to human error.

Accordingly, the present specification addresses these and other issues. Specifically, the present specification describes a sensor that is used to measure the presence or absence of a working ejector, by detecting the presence of drop as it falls from the printhead towards the substrate. With the drop detected, the system may determine a drop velocity and/or drop weight measurement. By comparing 1) the drop velocity, 2) the drop weight, or 3) a change to either the drop velocity and drop weight against a threshold value, the system can carry out system-based, and not user-based, remedial actions.

As used in the present specification and in the appended clams, the term “drop velocity measurement” and “drop weight measurement” may be values indicating a drop velocity and drop weight value, or a drop velocity change value and a drop weight change value, respectively. For example, the drop velocity measurement may be a value indicative of a drop velocity, for example of 9.5 m/s, or may be a value indicative of a change to drop velocity from a predetermined value, for example of 1.0 m/s.

Similarly, as used in the present specification and in the appended clams, the term “drop velocity threshold value” and “drop weight threshold value” may be values indicating a drop velocity and drop weight value, or a drop velocity change value and a drop weight change value, respectively. For example, the drop velocity threshold value may be a value indicative of a threshold drop velocity, for example of 9 m/s, or may be a value indicative of a threshold change to drop velocity, for example of 1.2 m/s.

Further, as used in the present specification and in the appended claims, the term “threshold” may be a lower-bound threshold or an upper-bound threshold. For example, a drop velocity change upper-bound threshold may be 1.2 m/s. Accordingly, a measurement that is “beyond” an upper-bound threshold is a measurement greater than the upper-bound threshold. As another example, a drop velocity lower-bound threshold may be 9 m/s. A measurement that is “beyond” a lower-bound threshold is a measurement less than the lower-bound threshold.

Specifically, the present specification describes a system. The system includes a drop detector to detect when a drop of print fluid is ejected from a printhead. A database of the system stores drop velocity threshold values. A controller of the system calculates a drop velocity measurement of an ejected drop, compares the drop velocity measurement against a drop velocity threshold value and, responsive to the drop velocity measurement being beyond the drop velocity threshold range, triggers a remedial action at the printhead.

The present specification also describes a method. According to the method, a drop characteristic measurement of a drop of print fluid ejected from a printhead is detected. The drop characteristic may be at least one of a drop velocity and a drop weight. The drop characteristic measurement is compared against a threshold value and when the drop characteristic measurement is beyond the threshold value, a remedial action is triggered.

The present specification also describes a non-transitory machine-readable storage medium encoded with instructions executable by a processor. The machine-readable storage medium comprising instructions to: determine, based on print system and print fluid characteristics, a threshold drop velocity value and a threshold drop weight value. The instructions are also executable to 1) detect a drop velocity measurement of a drop of print fluid ejected from a printhead and 2) calculate a drop weight measurement of the drop based on a detected drop velocity measurement. The instructions are also executable to compare at least one of the drop velocity measurement and drop weight measurement to a respective threshold value. When the drop velocity measurement is beyond the threshold drop velocity value, the instructions are executable to trigger a printhead alignment. When the drop weight measurement is beyond the threshold drop weight value, the instructions are executable to trigger a printhead color calibration.

Such a system, method, and machine-readable storage medium 1) remove a user input as a trigger for remedial actions; 2) adjust calibration frequency based on a particular printhead characteristics; 3) facilitate print fluid tracking; and 4) enable printhead product management. However, it is contemplated that the systems and methods disclosed herein may address other matters and deficiencies in a number of technical areas.

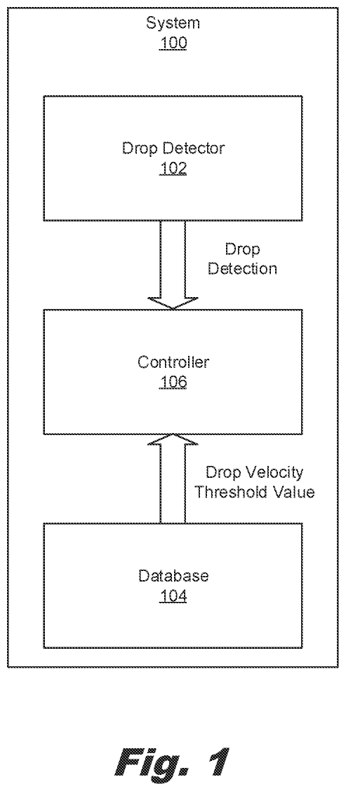

Turning now to the figures, FIG. 1 is a block diagram of a system (100) for carrying out drop-based remedial actions for a printhead, according to an example of the principles described herein. As described above, the system (100) includes a drop detector (102) which can detect the presence of a drop of fluid ejected from a printhead. An output of the drop detector (102) is processed to determine a drop velocity and/or drop weight measurement. As described above, the drop velocity measurement and/or drop weight measurement may be 1) measurements of the drop velocity or drop weight or 2) measurements of a drop velocity change or drop weight change. When the drop velocity and/or drop weight measurements change by a threshold amount, there may be a visual artifact that is visible on the printed product. Accordingly, the present system (100) compensates for the change in drop velocity and/or drop weight that may occur naturally over time or as the result of a malfunction or damage to the printhead.

Specifically, the system (100) includes a drop detector (102) to detect when a drop of print fluid is ejected from a printhead. The drop detector (102) may take many forms. In one example, the drop detector (102) may include an emitter to emit a beam of light and an optical receiver to receive the beam. An ejected drop may pass through and interrupt the light beam. This interruption is detected by the optical receiver and passed to a controller (106) which may calculate the drop velocity measurement (i.e., either the drop velocity itself or a change in drop velocity from a predetermined amount). The measurement in which the drop is detected can be translated into time from the drop ejection to the drop detection. This amount of time can be translated into drop velocity taking into account distance from nozzle to drop detector (102).

There may also be a relationship between drop velocity and drop weight. That is, a change in drop velocity may be mapped to a change in drop weight. This mapping may be specific to a particular print system and may be determined via experimentation. Accordingly, the system (100) includes a database (104) that may include a mapping between drop velocity measurements and drop weight measurements such that when a change in drop velocity is detected, the controller (106) may determine a corresponding change in drop weight. As a change to the drop weight may trigger different remedial actions as compared to those triggered by a change in drop velocity, such conversion allows for detection of a wider variety of action-triggering events.

The database (104) also stores a drop velocity threshold value and/or a drop weight threshold value. Such threshold values may be of drop velocity and drop weight directly or may be of changes to drop velocity and changes to drop weight. Such thresholds may also be lower-bound or upper-bound thresholds. For example, a drop velocity threshold may be a lower-bound drop velocity measurement threshold. By comparison, the drop velocity threshold may be an upper-bound drop velocity change threshold.

That is, a certain amount of variation in drop velocity may not result in artifacts that are discernible to a human eye. Accordingly, the database (104) stores a threshold value that indicates for what drop velocity measurement and drop weight measurement a resulting artifact would be perceptible to a user. In some examples, the threshold values may be specific to a particular print system and may be determined based on any number of factors including a print quality of the print system, a carriage speed, a distance to the substrate, and a nominal drop velocity. For example, Table 1 below provides a threshold drop velocity change that would result in a pixel error that would be perceptible to a user, which in this example, may be 6 pixels at 600 dots per inch (dpi).

As used in the present specification and in the appended claims, the term “pixel error” refers to how far from an expected position a drop can be without impacting the overall quality of the printed product. That is, it may be determined that no more than a 6-pixel misalignment at 600 dpi is desirable for a target print system, as any more error would be perceptible to a user.

TABLE 1

| Printer Characteristic | Value |
|---|---|
| Distance to substrate | 2 millimeters (mm) |
| Nominal DV | 10 meter per second (m/s) |
| Carriage speed | 1.524 (m/s) |
| Nominal travel time | 0.2 millisecond (ms) |
| Min Pixel error for IQ impact | 6 pixels @ 600 dpi |
| Min Travel time for IQ impact | 0.025 (ms) |
| Min DV change for IQ impact | 1.2 (m/s) |

Accordingly, given a print system with a distance between the printhead and the substrate of 2 millimeters, a nominal or expected drop velocity of 10 meters per second, and a carriage speed of 1.524 meters per second, it may be determined that a drop velocity change of 1.2 meters per second or more would result in a pixel error greater than 6 pixels.

In this example, when a drop velocity change greater than 1.2 m/s is detected (which may be mapped to a 0.5 picoliter (pi) drop weight change), the controller (106) may execute a remedial action. That is, the controller (106) compares the measured drop velocity change against a drop velocity change threshold value and responsive to the drop velocity change being beyond the drop velocity change threshold range, triggers a remedial action. For example, a drop velocity change of 1.2 m/s is equivalent to a 2-pixel misalignment in scan axis. In this example, if a drop velocity of 1.3 m/s is detected, the remedial action may be a printhead realignment to maintain image quality. This drop velocity change may map to a drop weight change of 0.5 pl which may result in a color variation of between 0.2 and 0.5 dL. In this example, dL refers to a difference in color value and may be dependent upon the colorant. That is, the color value of a pixel may be identified based on the CIELAB color space which defines a color in terms of a lightness component, a red component, a green component, a blue component, and a yellow component. The difference between colors, i.e., an expected color and an actual deposited color at the pixel, may be quantified based on their coordinates int eh CIELAB color space. To account for the drop weight change, the controller (106) may trigger a color calibration to maintain image quality.

In an example, a drop velocity measurement and/or drop weight measurement is detected during a print job, that is as the printhead is actively depositing print fluid to form text and/or images. In this example, the controller (106) may execute the remedial action following completion of an existing print job. As such, printing is not interrupted to perform the target remedial action.

As described, the controller (106) executes a remedial action based on measured drop velocity values determined at the printhead. In some examples, the controller (106) may further execute the remedial action based on historical data. For example, the database (104) may include time-based historic drop velocity information collected from multiple printheads. Based on this information, the controller (106) may adjust a servicing routine for the printhead.

For example, the controller (106) may include data indicative of an overall amount of print fluid consumed by the printhead. Consulting the database (104), the controller (106) may determine that historically, similar printheads that have consumed a similar amount of print fluid are more susceptible to above-threshold changes to drop velocity and/or drop weight. Accordingly, the controller (106) may trigger more frequent servicing, i.e., drop detection and drop velocity comparisons. That is, the controller (106) may selectively activate the drop detector (102) to detect the drop of fluid and may selectively calculate the drop velocity. Specifically, the controller (106) may selectively activate the drop detector (102) based on time-based historic drop velocity information collected from multiple printheads.

As a specific example, the controller (106) may trigger more or less frequent servicing based on historic drop velocity data of printheads that are similar to the printhead, for example in age, type, model, printing fluid used, etc. In this example, remedial actions may be proactive instead of reactive. That is, rather than waiting for a drop velocity changes to fall beyond an upper-bound threshold value, the system (100) may determine an estimated time at which the drop velocity change is expected to be beyond the threshold value and may preemptively test the drop velocity more frequently to determine whether any calibration should be performed.

That is, through printer reporting, print fluid consumption can be linked to drop velocity loss and thus the moment a drop velocity loss is expected may be approximated. Accordingly, the more a specific print fluid batch is used, the better this batch is characterized, and the more accurate the estimation of drop velocity degradation will be. As such, the print system is better able to determine at supply insertion, when the system (FIG. 1, 100) should increase the monitoring level to more effectively apply remedial actions.

In an example, the historic drop velocity information is indexed by print fluid or printhead. That is, similar printheads may function similarly over time. Accordingly, historic drop velocity measures over time from printheads may be indicative of what drop velocity measures may be expected for a similar printhead currently being used. Similarly, print fluids may function similarly over time, such that historic time-based drop velocity measures indexed by print fluid may be indicative of what drop velocity measures may be expected when that print fluid is used in a printhead. As such, when a printhead and/or print fluid is used, historic data from similar printheads and/or similar print fluids may be used to predict when drop velocity and/or drop weight changes are expected to approach the threshold and a servicing routine may be changed based on the expected time, for by example increasing drop detection rates.

In addition to the testing being based on the time-based historic drop velocity information, the remedial action itself may be based on the time-based historic drop velocity information. For example, a remedial action may include the iterative flushing of a printhead with fluid and re-testing the printhead. Historic information may indicate that for a given printhead with a given print fluid, three iterations of 10 millimeters (mL) of fluid are used to recover a printhead. In this example, based on that historic information, rather than performing 3 iterations of 10 mL flushing, the recovery operation may include a single iteration of 30 mL flush, which may be more efficient.

In general, the controller (106) may include various hardware components, which may include a processor and memory. The processor may include the hardware architecture to retrieve executable code from the memory and execute the executable code. As specific examples, the controller (106) as described herein may include computer readable storage medium, computer readable storage medium and a processor, an application specific integrated circuit (ASIC), a semiconductor-based microprocessor, a central processing unit (CPU), and a field-programmable gate array (FPGA), and/or other hardware device.

The memory may include a computer-readable storage medium, which computer-readable storage medium may contain, or store computer usable program code for use by or in connection with an instruction execution system, apparatus, or device. The memory may include many types of memory including volatile and non-volatile memory. For example, the memory may include Random Access Memory (RAM), Read Only Memory (ROM), optical memory disks, and magnetic disks, among others. The executable code may, when executed by the controller (106), cause the controller (106) to implement at least the functionality of generating print instructions, which includes triggering remedial actions based on above-threshold changes to drop velocity and/or drop weight.

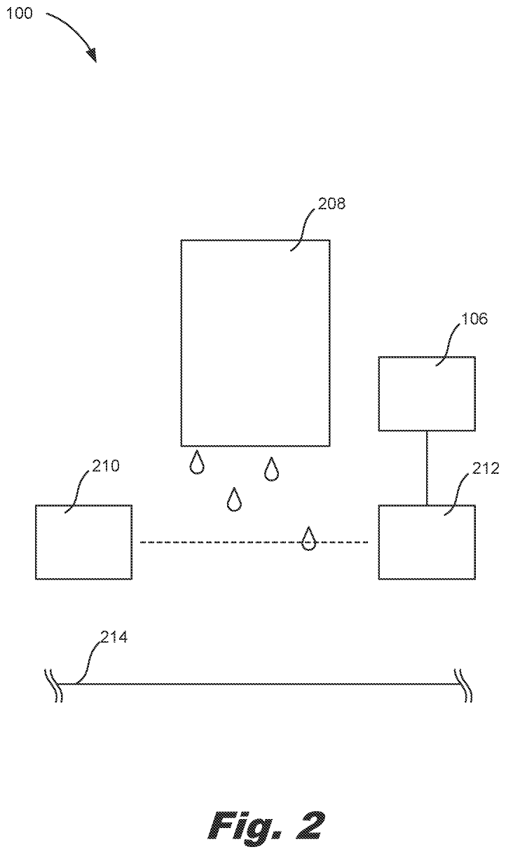

FIG. 2 is a diagram depicting the system (100) for carrying out drop-based remedial actions for a printhead (208), according to an example of the principles described herein. As described above, a printhead (208) may include an array of nozzles. The printhead (208) may be stationary or may scan across the surface of the substrate (214), which substrate (214) may be stationary or may traverse under the printhead (208). In an example print operation, the printhead (208) may move along a direction across the substrate (214) as print fluid drops are ejected in a pattern. When the printhead (208) reaches an edge of the substrate (214), the substrate (214) is advanced, and another print operation is performed where the printhead (208) traverses across the substrate (214) and ejectors are activated in sequence to produce another line of the pattern. In this iterative fashion, a complete printed job is performed.

The printhead (208) includes various ejectors to eject print fluid. The ejectors may be of varying types. In the case of a thermal inkjet operation, the ejector is a heating element. Upon receiving the firing signal, the heating element initiates heating of the print fluid the ejection chamber. As the temperature of the fluid in proximity to the heating element increases, the fluid may vaporize and form a drive bubble. As the heating continues, the drive bubble expands and forces the fluid out of the orifice. As the vaporized fluid bubble pops, a negative pressure within the ejection chamber draws fluid into the ejection chamber from the fluid supply, and the process repeats. This system is referred to as a thermal inkjet system.

In the case of a piezoelectric inkjet operation, the ejector is a piezoelectric element. Upon receiving the firing signal, the piezoelectric element changes shape which generates a pressure pulse in the ejection chamber. The pressure pulse pushes fluid out the opening. This system is referred to as a piezoelectric inkjet system.

Instructions to the printhead (208) produce a print fluid drop from a nozzle. However, as described above, it may be the case that as a printhead (208) ages, the operation of its components, i.e., the ejectors, change. The drop detector (FIG. 1, 102) allows for calibrations to be performed such that even as ejector performance changes, print quality may be maintained. Specifically, as a print fluid is ejected it follows a path. Along the path, the print droplets pass a drop detector (FIG. 1, 102) which may be an optical sensor positioned perpendicular to an ejection path of an ejected drop.

Specifically, the print fluid drop may pass between a light emitting diode (LED) (210) and a receiving photo diode (212). In an example, in response to the light received, the photo diode (212) may produce a current which is passed to the controller (106). When a print fluid drop fired from a nozzle passes through the narrow light beam between the LED (210) and the photo diode (212), the drop partially blocks the light input into the photo diode (212). As a result, the output current of the photo diode (212) decreases. The decrease in the output current of photo diode (212) is detected and transmitted to the controller (106) as a detected drop. Knowing the distance between the printhead (208) and the light beam, and knowing an exact ejection timing, the controller (106) may determine a drop velocity and may detect a drop velocity change over time. Moreover, consulting the database (FIG. 1, 104) which includes a mapping between drop velocity measurements and drop weight measurements, the controller (FIG. 1, 106) may also detect the drop weight and/or drop weight change. As described above, when these changes are greater than a threshold amount, a particular remedial action may be executed. While specific reference is made to an optical sensor, other types of sensors that are able to measure a drop velocity may be implemented.

In an example, the drop detector (FIG. 1, 102) may calculate drop velocity per nozzle. That is, the drop detector (FIG. 1, 102) may be able to identify which printhead (208) is malfunctioning. As such, any remedial action may be performed on a per-printhead basis. Specifically, the drop detector (FIG. 1, 102) components may be placed along the scan axis on the same level as the substrate (214). When executing the drop detection routine, the printhead (208) is placed above the drop detector (FIG. 1, 102) components and each nozzle is fired individually. The drop detector (FIG. 1, 102) determines the presence of a drop and by knowing the ejection time and detection time, the controller (FIG. 1, 106) may calculate the drop velocity. In an example, drop velocity is calculated per nozzle. However, remedial actions may be performed based on a threshold number of nozzles perform differently. Put another way, remedial actions may be executed based on the average drop velocity of the entire printhead (208).

By comparison, user-based alignments and calibrations may realign and/or recalibrate all printheads (208) in a print system whether they are operating correctly or not. Performing alignments and calibrations on printheads that are not misaligned may be ineffective and such unnecessary alignment and calibration may offset a correct alignment or calibration.

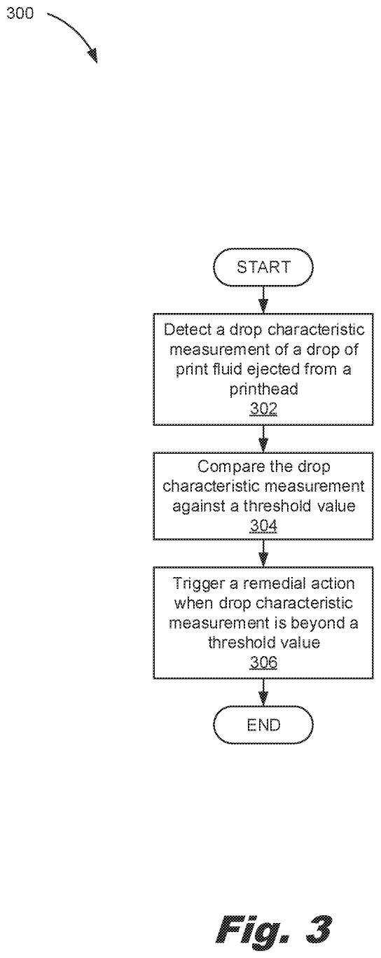

FIG. 3 is a flow chart of a method (300) for carrying out drop-based remedial actions for a printhead (FIG. 2, 208), according to another example of the principles described herein. According to the method (300), the system (FIG. 1, 100) detects (block 302) a drop characteristic measurement of a drop of print fluid ejected from a printhead (FIG. 2, 208). The drop characteristic may be a drop velocity or a drop weight and the measurement may be a direct measurement, i.e., of a drop velocity or drop weight, or may be an indirect measurement, i.e., of a drop velocity change or a drop weight change.

As an example, the system (FIG. 1, 100) may calculate either a drop velocity or a drop weight of the drop. That is, the controller (FIG. 1, 106) may determine an ejection event and the drop detector (FIG. 1, 102) may detect the time when a drop passes by. Knowing the distance between the printhead (FIG. 2, 208) and the drop detector (FIG. 1, 102) and the time for a drop to fall between the printhead (FIG. 2, 208) and the drop detector (FIG. 1, 102), the controller (FIG. 1, 106) may determine the drop velocity. Moreover, as described above, there may be a printhead (FIG. 2, 208) specific mapping between drop velocity and drop weight, which may be stored in a database (FIG. 1, 104). Accordingly, based on such a mapping, the controller (FIG. 1, 106) may determine a drop weight from the drop velocity. Knowing a measured drop velocity and/or weight and a reference drop velocity and/or weight, for example from initial settings of the printhead (FIG. 2, 208), the controller (FIG. 1, 106) may be able to detect a change in either characteristic.

The system (FIG. 1, 100), and more specifically the controller (FIG. 1, 106) may compare (block 304) the drop characteristic measurement against a threshold value. More specifically, the database (FIG. 1, 104) may indicate, for a given printhead (FIG. 2, 208) and/or print fluid, a drop velocity, drop weight, or change in either, that would result in a user-perceptible error on the printed product. The controller (FIG. 1, 106) may receive a measured value (i.e., drop velocity, drop weight, or change in either) and may compare it to a corresponding threshold value in the database (FIG. 1, 104). For example, the measured value may be a drop velocity of 9 m/s and the threshold value may be a lower-bound value of 8.8 m/s, indicating that if drop velocity is below 8.8 m/s, a user may perceive a printed artifact. In another example, the measured value may be a drop velocity change of 1.3 m/s from a nominal value of 10 m/s and the threshold drop velocity change value may be an upper-bound value of 1.2 m/s indicating that if the drop velocity changes by more than 1.2 m/s for the 10 m/s value, a user may perceive a printed artifact.

When the drop characteristic measurement is beyond the threshold value (whether the value is an upper-bound or lower bound value), the system (FIG. 1, 100) may trigger (block 306) a remedial action. The remedial action may take a variety of forms. For example, the remedial action may include invalidating a current calibration. That is, over time, a printhead (FIG. 2, 208) may be calibrated and aligned such that it accurately deposits print fluid in desired locations to form a desired text and/or images. However, when drop velocity or drop weight changes by a threshold amount, those calibrations may no longer be accurate. Accordingly, the system (FIG. 1, 100) may invalidate a current calibration, which may be inaccurate, so that the printhead (FIG. 2, 208) is no longer operating based on an inaccurate calibration.

The remedial action may also include re-calibrating the printhead (FIG. 2, 208). For example, the controller (FIG. 1, 106) may trigger a new color calibration, which would account for any change in drop weight change. In another example, the controller (FIG. 1, 106) may trigger a new printhead alignment which would account for a change in drop velocity.

In another example, the remedial action may be a recovery operation. That is, there may be any number of unexpected circumstances, aside from expected aging of the printhead (FIG. 2, 208), that lead to printhead malfunction. Examples include blocked nozzles or fluid conduits. In such an example, a recovery operation, such as wiping the printhead against a dry or wet textile cloth or rubber wiper may be executed to clean the printhead (FIG. 2, 208) surface. In another example, a recovery operation may include spitting addition print fluid or performing a print fluid flush with applied pressure to clear out the conduits. While particular reference is made to specific recovery operations, a number of recovery operations may be triggered based on a detected drop velocity and/or weight change.

In another example, the remedial action may include providing a notification to a user such that the user may prevent the use of a particular print fluid batch. For example, as described above it may be that characteristics of the print fluid itself trigger drop velocity and/or drop weight changes. For example, a viscosity of the print fluid or a change in viscosity over time may impact the drop velocity and/or weight, which as described above may impact the location and amount of print fluid dropped which may have an impact on print quality. In some examples, changes in drop velocity and/or drop weight may be accounted for via calibration and/or alignment. However, in some cases the drop velocity and/or weight change may occur frequently enough or be enough outside a threshold range that it may result in more than a desired number of re-calibration or re-alignment operations. In this example, the controller (FIG. 1, 106) may either automatically, or following response to a user-prompt, prevent the use of a print fluid. For example, the controller (FIG. 1, 106) may automatically may reject the print fluid for use in the print system. In this example, the controller (FIG. 1, 106) may provide a prompt to user of the rejection.

In another example, the remedial action may include altering a servicing routine for the printhead (FIG. 2, 208). For example, it may be the case that during a period of time, a particular printhead (FIG. 2, 208) may warrant more closely-spaced drop characteristic measurements as during that period of time the printhead (FIG. 2, 208) may be more prone to drop velocity and/or drop weight changes. Accordingly, the controller (FIG. 1, 106) may alter a servicing routine by performing calibration checks, i.e., servicing, more frequently. For example, from historic data it may be determined that a particular printhead (FIG. 2, 208) sees drop velocity changes over the first 5 liters, but then drop velocity stabilizes after that point in time. Accordingly, the controller (FIG. 1, 106) upon detecting a drop velocity change within the first 5 liters, may perform drop velocity checks more frequently until print fluid consumption passes 5 liters, at which point the controller (FIG. 1, 106) may perform drop characteristic measurements less frequently.

In yet another example, the remedial action may be to provide a notification to a user to take supplemental remedial action. For example, it may be that the printhead (FIG. 2, 208) has reached a stage in life where enough calibrations and alignments are to be performed to keep it in proper working order, that it would be more effective to replace the printhead (FIG. 2, 208). As another example, it may be the case that re-calibrations and re-alignments and recovery operations may not be able to adequately account for the drop velocity and/or drop weight change. In this example, the controller (FIG. 1, 106) may provide a prompt for the user to replace a printhead (FIG. 2, 208) to address the matters.

In another example, if the drop velocity changes within a few cycles of usage, the remedial action may include additional servicing and re-measuring of drop velocity. For example, if a printhead (FIG. 2, 208) has recently been installed and there is a drop in performance, it may be the result of the print system not having completely purged old print fluid from the printhead (FIG. 2, 208). Accordingly, a change in drop velocity within the first consumption of new print fluid may not indicate that something is wrong, but may indicate that a recovery operation, such as a print fluid flush, should be performed. Accordingly, if a sharp drop in drop velocity is detected, a recovery operation may be performed and a re-measuring to determine if the system is recovered. In other words, in some example multiple remedial actions, e.g., a recovery operation and re-calibration, may be implemented based on a detected change in drop velocity.

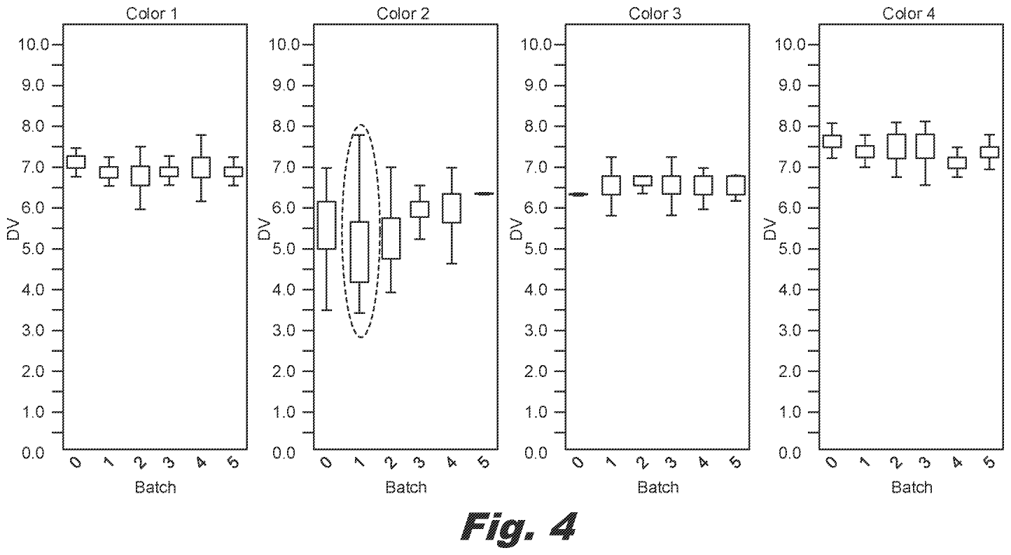

FIG. 4 depicts various drop velocity output graphs, according to an example of the principles described herein. Specifically, FIG. 4 depicts drop velocity measurements for various print fluid revisions of various colors. As described above, historic data for printhead (FIG. 2, 208) performance over time may be collected from various printheads (FIG. 2, 208) and may be correlated to print fluids by color and batch. In such an example, manufacturing differences and/or compositional differences between batches may alter the print fluid/printhead interactions between the different batches.

Such historic data qualifies the performance of print fluid batches. From such data, underperforming print fluid batches may be identified. The underperformance may be related to any number of circumstances including improper storage of the print fluid and a composition of the print fluid to name a few. In such an example, remedial action may be taken, such as prompting the user to verify the print fluid batch, change the print fluid batch, or take other remedial action. Doing so may reduce the print quality issues that may arise from using a print fluid that underperforms.

For example, in FIG. 4, the graphs depict drop velocity values for different colors and batches as boxplots. In this example, color 2 generally has higher variances with lower drop velocities. In particular, batch 1 of color 2 has high variation and low drop velocity. In this example, batches 0, 2, 3, 4, and 5 of color 2 may have altered servicing routines, i.e., drop detection and comparison more frequently. In such an example, the controller (FIG. 1, 106) may alter the servicing routine when an indication is received that batches 0, 2, 3, 4, or 5 is being used within the print system.

From this data, it may be determined that batch 1 of color 2 are underperforming. As such, the controller may prompt a remedial action. For example, the controller (FIG. 1, 106) may, via electronic communication from the printhead (FIG. 2, 208) identify that batch 1 of color 2 has been inserted, and may prevent use of this print fluid batch and may notify the user of such. In another example, the controller (FIG. 1, 106) may prompt the user to verify the print fluid batch, change the print fluid batch, or take other remedial action.

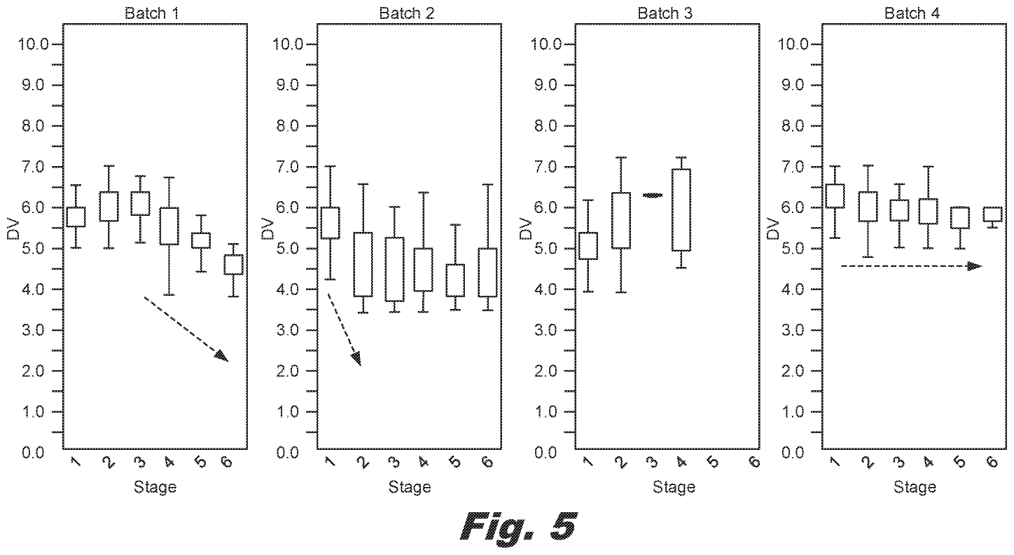

FIG. 5 depicts various drop velocity output graphs, according to an example of the principles described herein. Specifically, FIG. 5 depicts historical drop velocity measurements of different batches of a print fluid over time. Specifically, FIG. 5 depicts the drop velocity measurements as a function of stage, wherein a stage indicates an amount of print fluid consumed. The first graph indicates that batch1 generally has a sharp degradation starting around stage 4. Accordingly, the controller (FIG. 1, 106) may include adjusting the servicing routine for batch1 by increasing a monitoring frequency around stage 4.

The second graph indicates that batch2 generally has a sharp drop velocity change starting at stage 1, but then stabilizes. Accordingly, the controller (FIG. 1, 106) may either 1) disable batch 2 upon insertion as the stabilized drop velocity value may be lower than desired or 2) perform more frequent calibrations during the first stage if the stabilized drop velocity value is satisfactory.

The fourth graph indicates that batch 4 has consistent drop velocity through all stages. Accordingly, the servicing routine may be adjusted by performing measurements less often due to the stability of the drop velocity and drop weight. That is, if there is high drop velocity, indicating that the printhead (FIG. 2,208) and the print fluid are stable, then the controller (FIG. 1, 106) may perform servicing routines less often as the print fluid is not as susceptible to drop velocity changes.

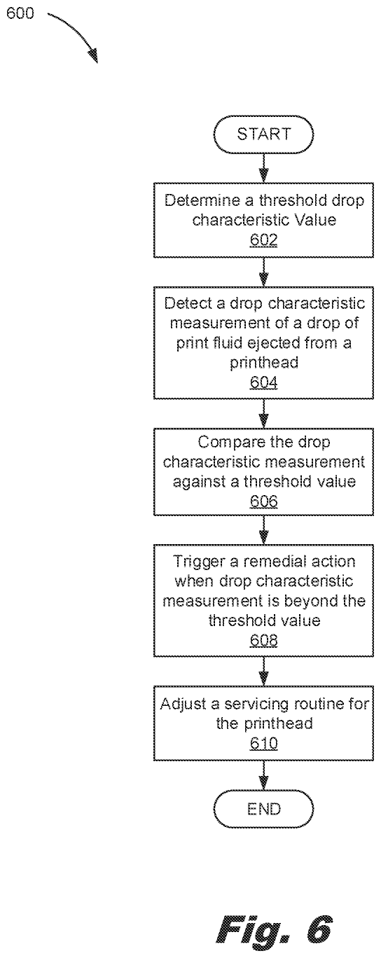

FIG. 6 is a flow chart of a method (600) for carrying out drop-based remedial actions for a printhead (FIG. 2, 208), according to another example of the principles described herein. As a first operation, the method (600) includes determining (block 601) a threshold drop characteristic value. As depicted above in Table 1, the threshold drop characteristic value may be determined based on various factors. One example of such a factor is a print quality of the print system. Table 1 above indicates a 6-pixel error as being the threshold for user-perceptible print artifacts. However, that pixel amount may vary based on the type of printing to be done. For example, with draft printing in black and white, greater pixel error may be acceptable as compared to high quality photographic printing. Other examples include the carriage speed, the distance to the substrate, and the nominal drop velocity. That is, each of these characteristics of the print system may affect an amount of drop velocity change that would result in a detectable print artifact.

With the threshold value determined (block 602), a drop characteristic measurement is detected (block 604) and compared (block 606) against a threshold value. If beyond the threshold value, a remedial action is triggered (block 608) as described above in connection with FIG. 3.

As described above, a servicing routine may be adjusted (block 610) based on at least one of ink consumption and historic information. For example, as indicated in FIG. 5, it may be that more frequent printhead servicing, i.e., testing for drop detection and performing any calibration/alignment, is performed more frequently, or at least more frequently for some particular stage of the life of the printhead (FIG. 2, 208). That is, adjusting (block 610) of the servicing routine may include adjusting a periodicity of the printhead servicing.

Also as described above, adjusting (block 610) the servicing routine may include adjusting an amount of print fluid used in printhead servicing and/or adjusting a number of printhead servicing cycles to perform. For example, it may be that servicing includes checking a printhead, performing a servicing operation, and then re-checking. If the printhead has not recovered, a subsequent servicing operation may be performed. Based on the historic information it may be determined that three servicing cycles are performed to fully recover a printhead. In this example, rather than performing three servicing cycles, a single cycle of perhaps a longer duration or using more servicing fluid may be executed during a servicing routine. That is, knowing how similar printheads (FIG. 2, 208) have historically performed, the controller (FIG. 1, 106) may adjust the servicing routing to do more or less servicing.

In summary, the evolution of drop performance can be recorded so that decision-making can take into account historic device behavior. As such, reactive measures may become proactive. Accordingly, by looking at historic behavior of a printhead (FIG. 2, 208), a tailored servicing routine can be executed prior to printing. The existence of historic data can also be helpful in identifying printheads (FIG. 2, 208) that consistently underperform by negatively affecting the overall print time/quality.

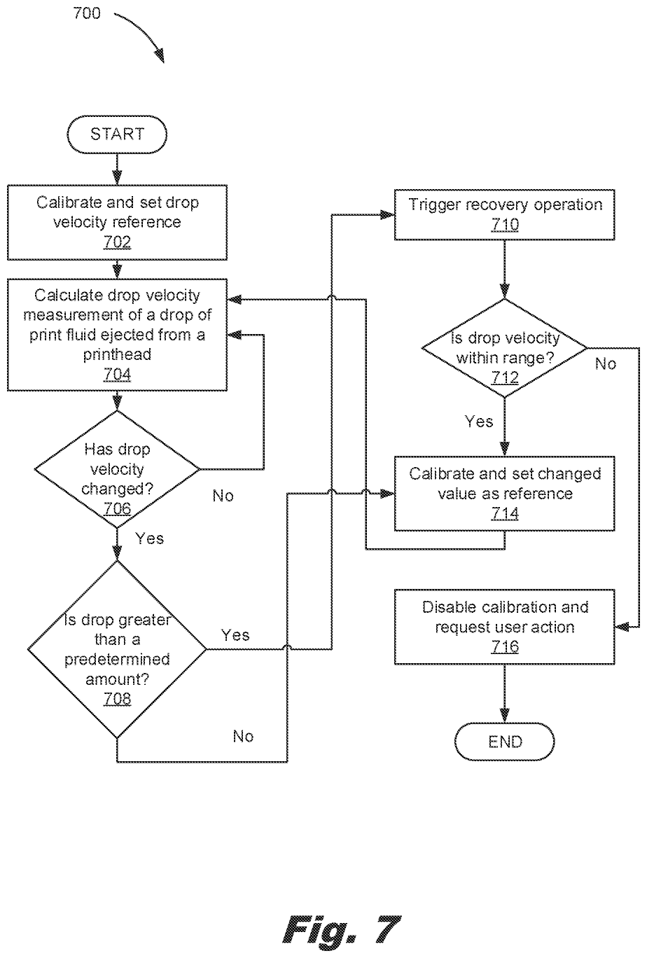

FIG. 7 is a flow chart of a method (700) for carrying out drop-based remedial actions for a printhead (FIG. 2, 208), according to another example of the principles described herein. According to the method (700), drop velocity reference values are set and calibrated (block 702). That is, a value against which a change to drop velocity is compared is determined. Following this operation, a drop velocity measurement is calculated (block 704) following drop ejection from a printhead (FIG. 2, 208). This may be performed as described above in connection with FIG. 3. If the drop velocity has not changed (block 706, determination NO), the system (FIG. 1, 100) continues to monitor and calculate (block 704) drop velocity of ejected drops.

If the drop velocity has changed (block 706, determination YES), it is determined whether the drop is greater than a predetermined amount (block 708). The predetermined amount may be user-defined. For example, an operator or manufacturer may determine that a change of more than 1-2% in drop velocity within a 1-day period or within 200 cubic centimeters of fired ink may be a predetermined amount that defines whether a change is sudden or not. A drop greater than this predetermined amount (block 708, determination YES), may indicate a condition other than a natural aging of the printhead (FIG. 2, 208) has led to a misalignment or miscalibration such that a recovery operation may be triggered (block 710). As described above, the recovery operation may include the above-mentioned wiping, spitting, or flushing of a printhead (FIG. 2, 208). Following such a recovery operation, the drop velocity may be measured again to determine whether it is within the threshold range. If so, (block 712, determination YES), the system (FIG. 1, 100) may calibrate (block 714) and set the changed drop velocity value as the reference. If not (block 712, determination NO), a notification may be presented to the user to request (block 716) user action to remedy the situation by, for example, replacing the printhead (FIG. 2, 208).

For example, a printhead (FIG. 2, 208) may have a reference drop velocity of 10 m/s which may change suddenly to 6 m/s. Following a recovery operation, it may be that the drop velocity is 9 m/s, which may trigger a re-calibration, but may be accounted for via a calibration such that print quality is not affected. By comparison, following a recovery operation it may be that the drop velocity remains at 6 m/s, for which a calibration and/or realignment may still result in print artifacts. In this example, as there may not be a way to account for such a change in drop velocity the controller (FIG. 1, 106) may request (block 716) user action to address the matter.

If the drop is not greater than the predetermined amount (block 708, determination NO), a calibration (block 714) may be carried out. That is, some changes to drop velocity and drop weight may be attributable to the life stage, or print fluid consumption, of the printhead (FIG. 2, 208). In this example, a calibration (block 714) may be sufficient to address any change in drop velocity.

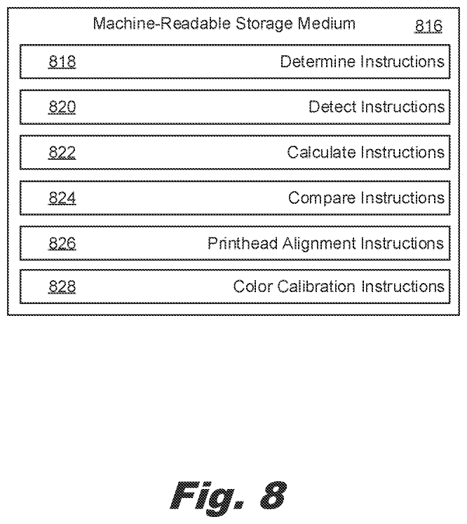

FIG. 8 depicts a non-transitory machine-readable storage medium (816) for carrying out drop-based remedial actions at a printhead, according to an example of the principles described herein. To achieve its desired functionality, a computing system includes various hardware components. Specifically, a computing system includes a processor and a machine-readable storage medium (816). The machine-readable storage medium (816) is communicatively coupled to the processor. The machine-readable storage medium (816) includes a number of instructions (818, 820, 822, 824, 826, 828) for performing a designated function. The machine-readable storage medium (816) causes the processor to execute the designated function of the instructions (818, 820, 822, 824, 826, 828). The machine-readable storage medium (816) can store data, programs, instructions, or any other machine-readable data that can be utilized to operate the printing device. Machine-readable storage medium (816) can store computer readable instructions that the processor of the controller can process, or execute. The machine-readable storage medium (816) can be an electronic, magnetic, optical, or other physical storage device that contains or stores executable instructions. Machine-readable storage medium (816) may be, for example, Random Access Memory (RAM), an Electrically Erasable Programmable Read-Only Memory (EEPROM), a storage device, an optical disc, etc. The machine-readable storage medium (508) may be a non-transitory machine-readable storage medium (508).

Referring to FIG. 8, determine instructions (818), when executed by the processor, cause the processor to determine, based on print system and print fluid characteristics, a threshold drop velocity value and a threshold drop velocity weight value. Detect instructions (820), when executed by the processor, may cause the processor to detect a drop velocity measurement of a drop of print fluid ejected from a printhead, which drop velocity measurement may be of the drop velocity value or a change in a drop velocity value against some predetermined value. Calculate instructions (822), when executed by the processor, may cause the processor to calculate a drop weight measurement of the drop based on a detected drop velocity measurement. As with the drop velocity measurement, the drop weight measurement may be of the drop weight value or a change in a drop weight value against some predetermined value. Compare instructions (824), when executed by the processor, may cause the processor to, compare at least one of the drop velocity measurement and drop weight measurement to a respective threshold value. Printhead alignment instructions (826), when executed by the processor, may cause the processor to trigger a printhead alignment when the drop velocity measurement is beyond the threshold drop velocity value. Color calibration instructions (828), when executed by the processor, may cause the processor to trigger a printhead color calibration when the drop weight measurement is beyond the threshold drop weight value.

Such a system, method, and machine-readable storage medium 1) remove a user input as a trigger for remedial actions; 2) adjust calibration frequency based on a particular printhead characteristics; 3) facilitate print fluid tracking; and 4) enable printhead product management. However, it is contemplated that the systems and methods disclosed herein may address other matters and deficiencies in a number of technical areas.

What is claimed is:

1. A system, comprising:
a drop detector to detect when a drop of print fluid is ejected from a printhead;
a database to store a drop velocity threshold value; and
a controller to:
calculate a drop velocity measurement of an ejected drop;
compare the drop velocity measurement against the drop velocity threshold value; and
responsive to the drop velocity measurement being beyond the drop velocity threshold value, trigger a remedial action at the printhead.

2. The system of claim 1, wherein:
the drop velocity measurement is a drop velocity change; and
the drop velocity measurement being beyond the drop velocity threshold value comprises the drop velocity change being greater than the drop velocity threshold value.

3. The system of claim 1, wherein the controller is to execute the remedial action following completion of an existing print job.

4. The system of claim 1, wherein:
the drop detector is to calculate drop velocity per nozzle; and
the remedial action is to be performed on a per-printhead basis.

5. The system of claim 1, wherein the controller is to selectively activate the drop detector to detect the drop of print fluid and to calculate the drop velocity measurement.

6. The system of claim 5, wherein the controller is to selectively activate the drop detector based on time-based historic drop velocity information collected from multiple printheads.

7. The system of claim 6, wherein the historic drop velocity information is indexed by at least one of print fluid and printhead.

8. The system of claim 6, wherein the remedial action is based the time-based historic drop velocity information.

9. A method, comprising:
detecting a drop characteristic measurement of a drop of print fluid ejected from a printhead, wherein a drop characteristic comprises at least one of a drop velocity and a drop weight;
comparing the drop characteristic measurement against a threshold value; and
when the drop characteristic measurement is beyond the threshold value, triggering a remedial action.

10. The method of claim 9, wherein the remedial action comprises at least one of:
invalidating a current calibration;
re-calibrating the printhead;
performing a recovery operation;
altering a servicing routine for the printhead; and
providing a notification to a user to take supplemental remedial action.

11. The method of claim 9, further comprising adjusting a servicing routine for the printhead based on at least one of print fluid consumption and historic information.

12. The method of claim 11, wherein adjusting the servicing routine comprises adjusting at least one of:
a periodicity of printhead servicing;
an amount of print fluid used in printhead servicing; and
a number of printhead servicing cycles to perform.

13. The method of claim 11, wherein adjusting a servicing routine is performed per stage of printhead life.

14. A non-transitory machine-readable storage medium encoded with instructions executable by a processor, the machine-readable storage medium comprising instructions to:
determine, based on print system and print fluid characteristics, a threshold drop velocity value and a threshold drop weight value;
detect a drop velocity measurement of a drop of print fluid ejected from a printhead;
calculate a drop weight measurement of the drop based on a detected drop velocity measurement;
compare at least one of the drop velocity measurement and drop weight measurement to a respective threshold value;
when the drop velocity measurement is beyond the threshold drop velocity value, trigger a printhead alignment; and
when the drop weight measurement is beyond the threshold drop weight value, trigger a printhead color calibration.

15. The non-transitory machine-readable storage medium of claim 14, wherein the threshold drop velocity value and the threshold drop weight value are determined based on at least one of:
a print quality of the print system;
a carriage speed;
a distance to the substrate; and
a nominal drop velocity.
